(19) United States
(12) Patent Application Publication
(10) Pub. No.: US 2009/0327278 A1
(43) Pub. Date: Dec. 31, 2009

(54) SYSTEM AND METHOD FOR RANKING WEB CONTENT

(76) Inventor: Alex BARAN-SNEH, Tel-Aviv (IL)

Correspondence Address: The Law Office of Michael E. Kondoudis, 888 16th Street, N.W., Suite 800, Washington, DC, 20006, US

(21) Appl. No.: 12/484,391

(22) Filed: Jun. 15, 2009

Related U.S. Application Data
(60) Provisional application No. 61/075,764, filed on Jun. 26, 2008.

(51) Int. Cl. G06F 17/30; G06Q 10/00; G06Q 50/00

(52) U.S. Cl. 707/5; 707/3; 705/10; 707/E17.017; 707/E17.014; 707/E17.044

(57) ABSTRACT

A system and a method of ranking items comprising content published and updated in predefined websites through at least one communication network, where the websites enable viewers to respond to the items by inserting and transmitting responses to the items. The system and method enable monitoring the websites to identify items and content of the items; measuring parameters for each item of each of the predefined websites, where the parameters include responses associated with the item; and time parameter relating to the responses, and where the parameters are measured within predefined time-intervals; and ranking each item of each website at each predefined time-interval, according to a predefined calculation including the measured parameters.

### CROSS REFERENCE TO RELATED APPLICATION

This application claims the benefit of U.S. Provisional Patent Application 61/075,764, filed Jun. 26, 2008, which is incorporated herein by reference in its entirety.

### BACKGROUND

1. Field of the Invention

The present invention relates generally to the field of web content and more particularly to systems and methods for ranking web content items.

2. Related Art

Websites often include items, each item comprises at least one type of content (e.g. text, video and/or audio content). Some items, such as news items often allow viewers to transmit responses to the item, often called “talkbacks”, which can be published through the website. Responses to an item are mostly presented at the same webpage where the item is presented.

Items providing content of popular subjects usually receive a large amount of responses, allowing people to publish their views regarding the content of the item. Some websites screen some responses and only allow publishing responses considered “inoffensive”.

Web engines usually rate a webpage or a website according to the traffic it receives. Some engines rate WebPages according to the traffic, the content in relation to the search word as well as the time spent by users in each of the website's pages, presenting the users with most visited WebPages corresponding to their search. New websites present items that are associated with and/or owned by the website and do not enable viewing items of other websites. Nor do these websites allow presenting items of one or more websites according to the popularity of each item and the responses the item invoked in the public.

### BRIEF SUMMARY

According to one aspect of the invention, there is provided a computer implemented method of ranking web items comprising content published and updated in predefined websites through at least one communication network, wherein the websites enable viewers to respond to the items by inserting and transmitting responses to the items, each response comprising content, wherein at least some of inserted responses are presented at the website of the item.

The method may comprise: monitoring the websites to identify items and content of the items; measuring parameters for each item of each of the predefined websites, wherein the parameters include responses associated with the item; and time parameter relating to the responses, and wherein the parameters are measured within predefined time-intervals; and ranking each item of each website at each predefined time-interval, according to a predefined calculation including the measured parameters.

According to another aspect of the invention, there is provided a system for ranking web items comprising content published and updated in predefined websites through at least one communication network, wherein the websites enable viewers to respond to the items by inserting and transmitting responses to the items, each response comprising content, wherein at least some of inserted responses are presented at the website of the item.

The system may comprise: a main items analyzer enabling to communicate with multiple websites over the at least one communication network; and a presentation platform, wherein the analyzer enables monitoring the websites to identify items and content relating to the items; measuring parameters for each item of each of the predefined websites; and ranking each item of each website at each predefined time-interval, according to a predefined calculation including the measured parameters. The parameters may include responses associated with each the item; and at least one time related parameter, wherein the parameters are measured within predefined time-intervals, wherein the presentation platform enables presenting items according to the ranking of each of the items.

According to another aspect of the invention, there is provided a main items analyzer for ranking web items comprising content published and updated in predefined websites through at least one communication network, wherein the websites enable viewers to respond to the items by inserting and transmitting responses to the items, each response comprising content, wherein at least some of inserted responses are presented at the website of the item, wherein the main items analyzer enables communicating with multiple websites over the at least one communication network.

The main items analyzer may comprise: a monitoring module, which enables monitoring the websites to identify items and content of the items; and a ranking module, which enables measuring parameters for each item of each of the predefined websites; and ranking each item of each website at each predefined time-interval, according to a predefined calculation including the measured parameters, wherein the parameters include responses associated with each the item; and at least one time related parameter, wherein the parameters are measured within predefined time-intervals.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of a website including various items;

FIG. 2 is a flowchart, schematically illustrating a method of ranking items in websites, according to some embodiments of the invention;

FIG. 3 is a block diagram, schematically illustrating a system for ranking items in websites, according to some embodiments of the invention; and

FIG. 4 schematically illustrates a presentation platform operatively associated with a search engine of a system for ranking items in websites, according to some embodiments of the system illustrated in FIG. 3.

### DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, in some embodiments thereof, provides a computer implemented method and a system for ranking web items comprising content published and updated in predefined websites through a communication network.

Websites usually enable viewers to respond to the items by inserting and transmitting responses (usually textual responses, often called “talkbacks”) to the items, each response comprising content, wherein at least some of inserted responses are presented at the website of the item.

Websites' items may comprise any content of one or more content types such as text, images, video and/or audio content. The items may be, for example, news items, updating at times.

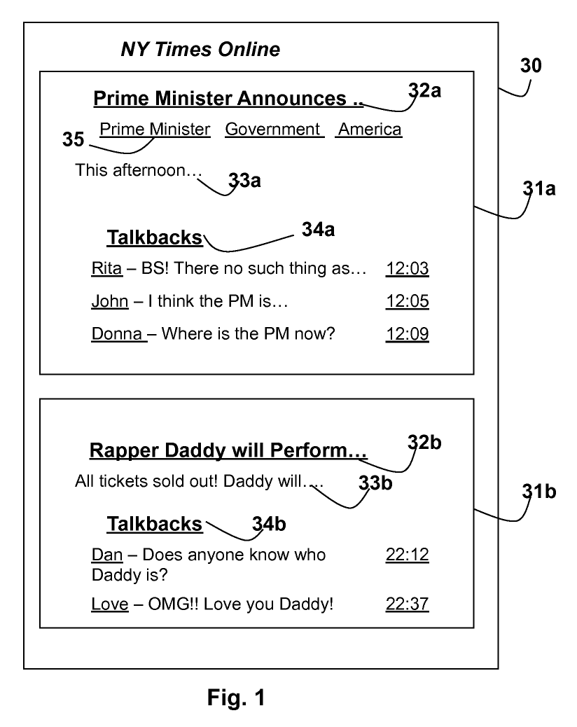

FIG. 1 is a schematic illustration of a website 30 including various items such as items 32a and 32.

Each item 31a or 32b may include a title 32a (e.g. a text defined as the title), tags-text 35 relating item 32a or 32b to terms that define the content of the item and the main content 33a or 33b, respectively.

Responses lists such as 34a or 34b may be presented underneath each item 31a or 31b, respectively, showing for example a response-title, responder identification code (e.g. nick name), main content of the response and the time each response was presented and/or received by the system.

In some websites, the responses are presented with a link, indicating the responder, the title of the response and the time of receiving/publishing the response, enabling viewers to enter the link to read the full content of the response to save presentation space of the network page to allow presenting all responses to the item at the same page.

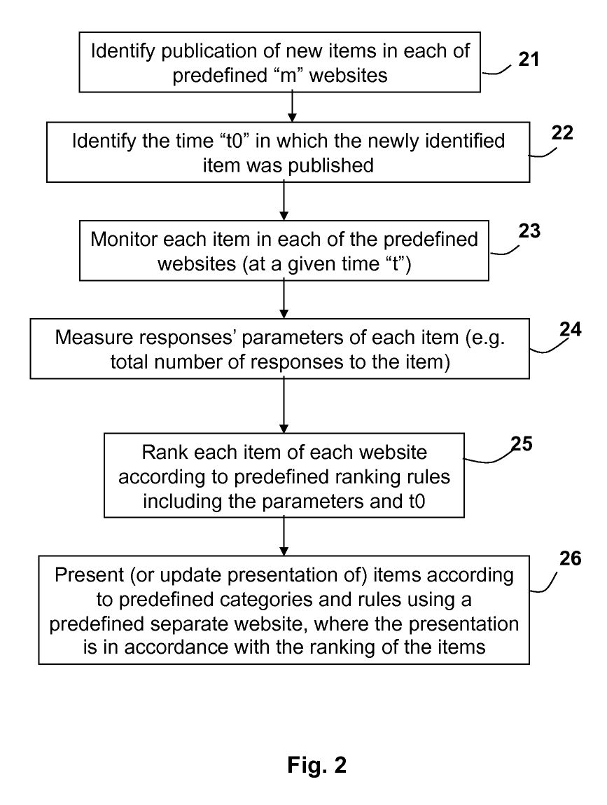

FIG. 2 is a flowchart, schematically illustrating a method of ranking items in websites, according to some embodiments of the invention. The method may comprise: monitoring each of the items of predefined websites 11 (enabling to identify items and content of items);

identifying publication of new items in each of the predefined websites 21;

identifying the time in which each item of each website was published in the website 22;

measuring parameters for each item of each of the predefined websites 23, where the parameters may relate to responses associated with each item; and one or more time parameters relating to the responses, where the parameters are measured within predefined time-intervals “Δt” (e.g. every five seconds);

monitoring each item in each website at predefined time intervals 24;

ranking each item of each website at each predefined time-interval, according to a predefined calculation including the measured parameters and the time in which the item was published in the website 25 (e.g. by dividing the overall number of responses to the item with the overall time passed, which means the time that has passed between the publication of the item and the measuring time, when the number of overall responses was measured); and

presenting each of the items according to predefined presentation rules which include the ranking of each of the items 26.

According to embodiments, the identification of the time in which the item was published may be carried out by checking for newly published items in the website every predefined time interval and verifying whether the publication time of the newly identified item is the time of measuring or earlier, in which case the earliest time parameter will be registered as the item's publication time.

Some websites present responses of a previously published item (referred to as “old item”) that is of the same content-subject in a newly published item (referred to as “new related item”) e.g. by copying and pasting the responses of the old item. To check and relate to these cases in the ranking, the system may further enable checking the difference between the publication time of each item (t0) and the issuing time of each of the item's responses (t1, t2, etc.): t1-t0=dt1; t2-t0=dt2, etc. If the difference exceeds a predefined time gap “T” a situation of “responses copying” is identified and the old item from which the responses were originally received may be searched and identified. In this case, the publication time of the new related item will be considered as the publication time of the old item, in which case the ranking will be smaller than that calculated according to the real publication time of the new related item. According to some embodiments, the publication time of the new related item may be calculated as the issuing time of the oldest response (e.g. as a default calculation or in cases where the old item is not identified).

Accordingly, the ranking may be calculated according to one or more calculations, producing one or more ranking types of each item. The ranking may include, for instance, dividing the overall number of issued responses N of each item with the overall time period T between the publication time of the item and the time at which the overall all number of responses N was measured N/T; and/or the overall number of responses issued in the last hour or within the first hour since the item was published) n/t.

According to some embodiments, each item may be associated with at least one category (e.g. famous people, fashion, politics, etc.), where each category may be predefined. Viewers may be enabled to view items according to categories by enabling the viewers to select a category; searching for items associated with the selected category; and presenting items associated with the selected category according to a descending ranking order of the items in the selected category.

Additionally or alternatively, the system may enable viewers to view items according to input text and/or by tag-input text by enabling the viewers to input free text; searching through content of items to find inputted text; and presenting items including the inputted text in the overall content of the item or as tag words associated with the item. The presentation of resulting corresponding items may be executed according to a descending ranking order of the items in the selected category.

According to some embodiments, categories may also be ranked where the category-ranking may be calculated by dividing the overall responses to all items associated with the same category by the summation of the overall time parameters of all items (each time parameter of each item equals the difference between the time of measuring the number of responses and the publication time of the item).

Popular terms may be searched through and identified in items' content, enabling to present viewers with items including these popular terms, where the popular terms are identified by searching through the content of the title text of each item and identifying non-trivial terms that appear in multiple number of items' titles, where triviality of terms is predefined (for example, most terms that are not prepositions, adjectives etc).

Each new item published may be identified and the time each new item was first presented at the website, by reviewing each of the predefined websites at predefined time intervals to identify new items and newly issued responses to each of the already published items and of the newly published ones.

According to some embodiments of the invention, the websites publishing items for which items are ranked may be defined and redefined over time by (i) administrators authorized to select and remove websites for items' ranking; and/or (ii) an automated mechanism enabling to automatically identify new relevant websites for items' ranking according to predefined search rules.

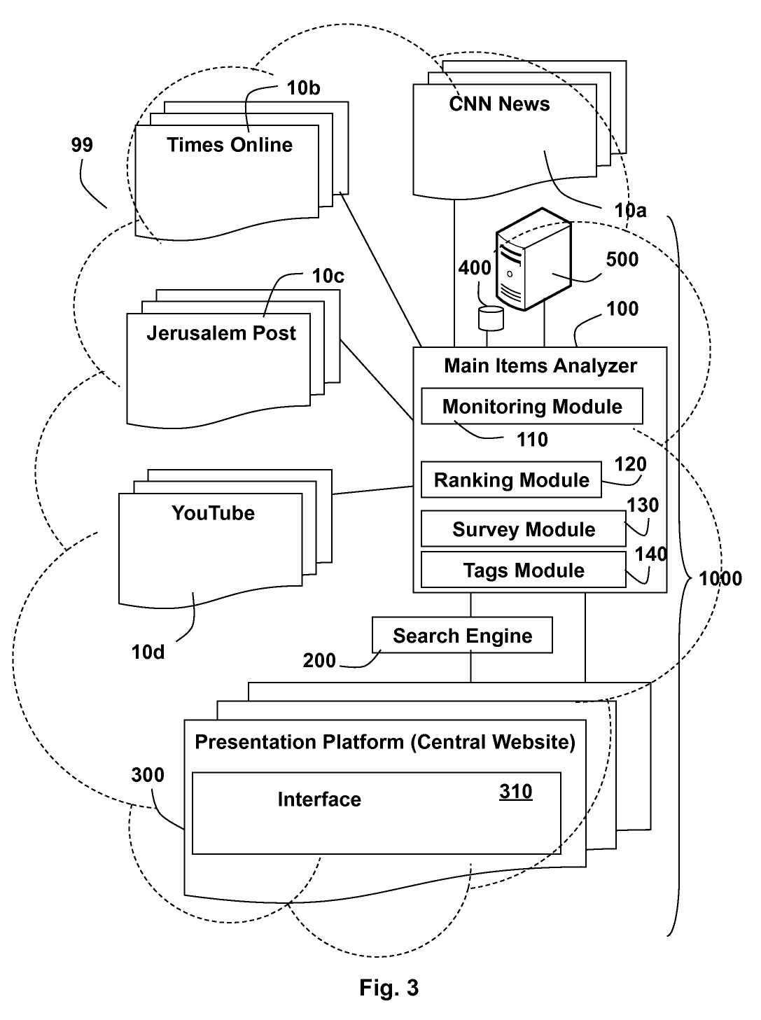

FIG. 3 is a block diagram, schematically illustrating a system 1000 for ranking web items comprising content published and updated in predefined websites such as websites 10a, 10b, 10c and/or 10d through at least one communication network 99 such as the internet or any other communication network known in the art, according to some embodiments of the invention. Websites 10a, 10b, 10c and/or 10d enable viewers to respond to the items by inserting and transmitting responses to the items, each response comprising content, where some of inserted responses are presented at the website of the item associated with the inserted response

System 1000 may comprise:

a main items analyzer 100 enabling to communicate with predefined websites 10a, 10b, 10c and/or 10d over communication network 99;

a presentation platform 300;

a search engine 200;

one or more databases 400; and

a server 500.

Main item analyzer 100 may enable monitoring websites 10a, 10b, 10c and/or 10d to identify items and content relating to the identified items; measuring parameters for each item of each of websites 10a, 10b, 10c and/or 10d; and ranking each item at each predefined time-interval “Δt”, according to a predefined calculation including the measured parameters.

The parameters may include at least one parameter that is associated with responses associated with each item; and at least one time related parameter, where the parameters are measured within predefined time-intervals Δt. Presentation platform 300 may enable presenting items according to the ranking of each of the items.

According to some embodiments, as illustrated in FIG. 3, presentation platform 300 may be a central website, which may be a separate website from websites 10a, 10b, 10c and/or 10d maintained by server 500 of system 1000.

The measured parameters and calculated ranking(s) of each item and an indicator enabling to identify each item (such as a URL address of the item) may be stored in database 400, enabling to retrieve the stored information and use it for statistical calculations relating to rankings of items, response times and the like. Database 400 may be an internal database (e.g. in server 500) and/or an external database.

According to some embodiments, as illustrated in FIG. 1, main items analyzer 100 may comprise:

a monitoring module 110 enabling to monitor items and retrieve the time and responses parameters of each item;

a ranking module 120 enabling to rank each item according to at least one predefined ranking calculation, using the measured parameters;

a survey module 130 enabling to retrieved and store data from and in database 400 and analyze the retrieved data for executing surveys of various kinds (such as advertising related surveys) by executing, for example, statistical calculations relating to the rankings and responses of items; and

a tags module 140 for associating each item to tags stored in system 1000 for further analysis and presentation functions.

Search engine 200 may enable searching for ranked items according to various search fields, where presentation platform 300 further enables presenting items according to the items' rankings and according to the search fields.

Search engine 200 may be a computer application which may be installed and operated by main items analyzer 100 or separately there from.

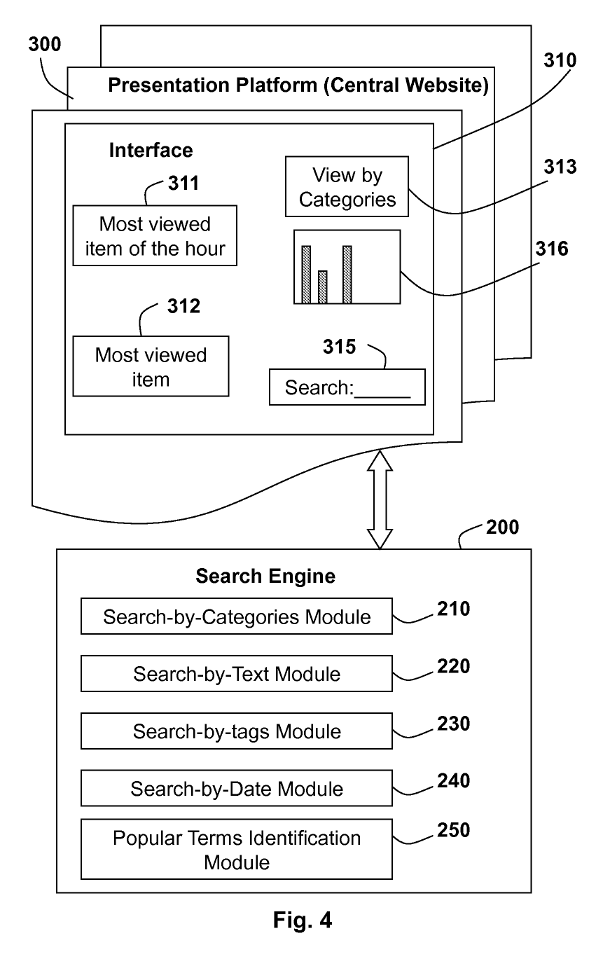

As illustrated in FIG. 3 and FIG. 4, presentation platform 300 may include an interface 310, enabling users (e.g. viewers) to input search terms, where search engine 200 further enables searching according to input of users.

According to some embodiments, tags module 140 may associate the item with tags stored in system 1000 by identifying tags from the item and searching for corresponding matching tags out of a list stored in system 1000 defining the found corresponding tags as the associated tags of the item. These associated tags may be stored and graded for presentational reasons. For example, the item may be presented at the presentation platform 300 showing the tags associated with the item and the grade of each item, where the associated tags may be presented according to a descending grading order. The grade may be given as a score according to the ranking level of item in relation to all other items tagged with the same associated tag. For example, an item having three associated tags: Politics, Economy and Israel may be graded (i) the third most popular (having the third highest rank) in relation to all other items tagged in Politics; (ii) the fifth most popular (having the fifth highest rank) in relation to all other items tagged in Economy; and (iii) the first most popular (having the highest rank) in relation to all other items tagged in Israel.

The tags list stored in the system may be updated and grow gradually over time including more and more tags.

According to some embodiments, as illustrated in FIG. 4, search engine 200 may comprise:

+a search-by-categories module 210 where interface 310 enables users to select a category through a category interface 313 and search-by-categories module 210 enables searching for items which correspond to the selected category and presenting the resulting corresponding items according to their rankings (e.g. “politics”, “celebrities” “environment”, etc.);

a search-by-text module 220 where interface 310 enables users to input text through a free text input field 315 and search-by-categories module 220 enables searching for items which correspond to the inputted text and presenting the resulting corresponding items according to their rankings;

a search-by-tags module 230 where interface 310 enables users to input tag-text and search-by-categories module 230 enables searching for items which correspond to the inputted tag-text by having the input tag-text included in the item's tags and presenting the resulting corresponding items according to their rankings; and

a search-by-date module 240 where interface 310 enables users to define a time range and search-by-categories module 240 enables searching for items which were published within the inputted time range and presenting the resulting published items according to their rankings.

According to some embodiments, as illustrated in FIG. 4, presentation platform 310 may further enable presenting additional parameters such as the most viewed item 312 presenting the item which currently includes the highest number of responses or the highest number of responses per time unit; and/or most viewed item of the hour 311, which indicates the item which currently includes the highest number of responses issued in the last hour. Calculating those parameters may be carried out by search engine 200 and/or by main items analyzer 100.

According to some embodiments, presentation platform, may further enable presenting graphical representations such as graphs and/or charts showing the number of responses (e.g. overall or average) per time interval (e.g. week or month) of each item and/or of each tag.

As illustrated in FIG. 1, the websites may publish the time and date when each response was received and/or published, therefore, system 1000, may retrieve these parameters from the website of the item and/or measure these parameters independently and use the published parameters for checking the measured ones.

According to some embodiments, multiple presentation platforms 300 may be defined in system 1000 for presenting ranking of items and highest ranked items. Additionally, system 1000 may enable presenting ranks and items through multiple types of presentation platforms 300 such as through website platform type; social networks presentation interfaces; messaging services (such as emails and/or SMS); etc.

System 1000 may further be used for further analysis and/or functionalities. For example, for measuring responses' related parameters in questions and answers (QA) forums, enabling users to estimate reply time for questions in each QA forum. As another example, system 1000 may be used by marketing entities for comparing different websites according to the responses related rankings of each item in the website and/or for estimating a product (e.g. by calculating ranking according to input text term which is a brand name or a product name etc.).

System 1000 may further be used as a tool for measuring response rates for items that are related (“threaded items”), such as items that relate to the same subject and/or items that have link connecting at least one of the items to the other.

According to some embodiments of the invention, the system may further enable ranking item, which are units in communication services such as chats and forums enabling, for example, to measure the overall number of responses in each thread (where the forum thread is defined as responses relating to the same initial message including the initial message) and the overall time of the thread (e.g. from the receiving of the initial message to the receiving of the last measured response) and ranking the thread by dividing the overall responses with the calculated time.

Although various features of the invention may be described in the context of a single embodiment, the features may also be provided separately or in any suitable combination. Conversely, although the invention may be described herein in the context of separate embodiments for clarity, the invention may also be implemented in a single embodiment.

While the invention has been described with respect to a limited number of embodiments, these should not be construed as limitations on the scope of the invention, but rather as exemplifications of some of the embodiments thereof, including a preferred embodiment. The scope of the invention should not be limited by what has been described, but by the appended claims and their legal equivalents.

What is claimed is:

1. A computer implemented method of ranking web items comprising content published and updated in predefined websites through at least one communication network, wherein said websites enable viewers to respond to said items by inserting and transmitting responses to said items, each response comprising content, wherein at least some of inserted responses are presented at the website of said item,
said method comprising:
monitoring said websites to identify items and content of said items;
identifying the time in which each item was published at the website;
measuring parameters for each item of each of the predefined websites, wherein said parameters relate to responses associated with said item; and time parameter relating to said responses, and wherein said parameters are measured within predefined time-intervals; and
ranking each item of each website at each predefined time-interval, according to a predefined calculation including said measured parameters and the time in which the item was published.

2. The method of claim 1, wherein said parameters include the overall number of responses issued within a time parameter, which indicates the time difference between the publication of the item and the measuring of the overall responses, wherein said calculating of said ranking of the item includes dividing the overall number of responses with said time parameter.

3. The method of claim 1 wherein said ranking includes identifying the number of responses of each item issued within the latest redefined time interval.

4. The method of claim 1 further comprising presenting items according to the ranking of each of the items.

5. The method of claim 4, further comprising associating each item with at least one category, wherein each category is predefined, wherein said method further comprises enabling viewers to view items according to categories by enabling the viewers to select a category; searching for items associated with said selected category; and presenting items associated with said selected category according to a descending ranking order of the items in the selected category.

6. The method of claim 4, further comprising enabling viewers to view items according to input text by enabling the viewers to input free text; searching through content of items to find inputted text; and presenting items including the inputted text according to a descending ranking order of the items in the selected category.

7. The method of claim 4, further comprising:
identifying popular terms in items and presenting items including said popular terms, wherein said popular terms are identified by searching through the content of a title text of each item and identifying non-trivial terms that appear in multiple number of items' titles, wherein triviality of terms is predefined; and
presenting items identified as having said popular terms in their titles.

8. The method of claim 4, further comprising:
identifying tags from the item and searching for corresponding matching tags out of a predefined list defining the found corresponding tags as the associated tags of the item;
storing said tags;
grading each tag according to predefined grading rules; and
presenting the graded tags of each item according to their grading.

9. The method of claim 8, further comprising enabling viewers to view items according to tags by enabling the viewers to input tag-text; searching through content of items in parts of the items defined as tags of the items to find inputted tag-text; and presenting items including the inputted tag-text according to a descending ranking order of the items in the selected category.

10. The method of claim 1, further comprising saving ranks of each item and identification of each item.

11. The method of claim 10, further comprising analyzing said saved data according to statistical calculations.

12. The method of claim 1, further comprising identifying new items and the time each new item was first presented at the website.

13. A system for ranking web items comprising content published and updated in predefined websites through at least one communication network, wherein said websites enable viewers to respond to said items by inserting and transmitting responses to said items, each response comprising content, wherein at least some of inserted responses are presented at the website of said item,
said system comprising:
a main items analyzer enabling to communicate with multiple websites over the at least one communication network; and
at least one presentation platform,
wherein said analyzer enables monitoring said websites to identify items, content relating to said items and to identify the time in which each item was published at the website; measuring parameters for each item of each of the predefined websites; and ranking each item of each website at each predefined time-interval, according to a predefined calculation including said measured parameters and the time in which the item was published,
wherein said parameters include responses associated with each said item; and at least one time related parameter, wherein said parameters are measured within predefined time-intervals, and
wherein said presentation platform enables presenting items according to the ranking of each of the items.

14. The system of claim 13, wherein said main items analyzer comprises:
a monitoring module enabling to monitor items and retrieve the time and responses parameters of each item; and
a ranking module enabling to rank each item according to at least one predefined ranking calculation.

15. The system of claim 15, further comprising at least one database enabling storing data relating to items and to parameters of each item and ranking data of each item; and retrieving stored data for further analysis.
wherein said main items analyzer further comprises a survey module enabling to retrieve said stored data from said at least one database and analyze said data to produce statistical information relating to items' responses.

16. The system of claim 13, further comprising at least one search engine enabling to search for ranked items according to various search fields, wherein said presentation platform further enables presenting items according to the items' rankings and according to said search fields, wherein said at least one presentation platform includes an interface, enabling users to input search terms, wherein said search engine further enables searching according to input of users.

17. The system of claim 16, wherein said search engine comprises:
a search-by-categories module wherein said interface enables users to select a category and said search-by-categories module enables searching for items which correspond to the selected category and presenting said corresponding items according to their rankings;
a search-by-text module wherein said interface enables users to input text and said search-by-categories module enables searching for items which correspond to the inputted text and presenting said corresponding items according to their rankings;
a search-by-tags module wherein said interface enables users to input tag-text and said search-by-categories module enables searching for items which correspond to the inputted tag-text by including said input text in the item's tags and presenting said corresponding items according to their rankings; and
a search-by-date module wherein said interface enables users to define a time range and said search-by-categories module enables searching for items which were published within said inputted time range and presenting said published items according to their rankings.

18. The system of claim 13, wherein said at least one presentation platform includes a website.

19. The system of claim 18, further comprising at least one server enabling to operate said main items analyzer, search engine and said website presentation platform.

20. A main items analyzer for ranking web items comprising content published and updated in predefined websites through at least one communication network, wherein said websites enable viewers to respond to said items by inserting and transmitting responses to said items, each response comprising content, wherein at least some of inserted responses are presented at the website of said item, wherein said main items analyzer enables communicating with multiple websites over the at least one communication network, said main items analyzer comprising:
a monitoring module, which enables monitoring said websites to identify items, content of said items and to identify the time in which each item was published at the website; and
a ranking module, which enables measuring parameters for each item of each of the predefined websites; and ranking each item of each website at each predefined time-interval, according to a predefined calculation including said measured parameters and the time in which the item was published, wherein said parameters include responses associated with each said item; and at least one time related parameter, wherein said parameters are measured within predefined time-intervals.
